(19) United States
(12) Patent Application Publication
(10) Pub. No.: US 2009/0064873 A1
(43) Pub. Date: Mar. 12, 2009

(54) WARM FOOD PRODUCT DISTRIBUTOR

(75) Inventor: Marco BIANCHI, Lido di Camaiore (IT)

Correspondence Address: FISH & RICHARDSON P.C., P.O. BOX 1022, MINNEAPOLIS, MN, 55440-1022, US

(73) Assignee: STARSTATUS TRADING INTERNACIONAL LDA, Madeira (PT)

(21) Appl. No.: 12/256,079

(22) Filed: Oct. 22, 2008

Related U.S. Application Data
(63) Continuation of application No. PCT/EP2007/004894, filed on Jun. 1, 2007.

(30) Foreign Application Priority Data
Jun. 1, 2006 (IT) PI2006A000061

(51) Int. Cl. A47J 37/00; A47J 43/00

(52) U.S. Cl. 99/450.1; 99/537

(57) ABSTRACT

An apparatus for supplying a single-dose portable express portion of a warm food product that can be eaten keeping it in hand, this warm food product having a stiff edible container (24) and a stuffing with at least one food component selected from the group comprised of: dressing of a pizza, in particular, comprising cheese. The apparatus comprises a conveyor belt (2) exposed to irradiation by at least one heat source (10), and optionally an auxiliary conveyor belt (1). The heated component (23) comprising cheese, is brought from the conveyor belt (2) towards an outlet where it falls in the edible container (24).

### CROSS-REFERENCE TO RELATED APPLICATIONS

This application is a continuation of International Application No. PCT/EP2007/004894, filed Jun. 1, 2007, which claims priority to Italian Application No. PI2006A000061 filed Jun. 1, 2006, both of which are incorporated herein by reference.

### DESCRIPTION

1. Field of the Invention

The present invention relates to the food distribution field and, in particular, it relates to an apparatus to obtain in an express and quick way a single-dose of a food product ready to be eaten, capable of shredding, heating and melting at least one food component before putting it in an edible portable container.

2. Description of the Technical Problem

A variety of types is known of portable food products, i.e. that can be eaten holding them in hand, consisting of an edible container, for example a wafer, filled with different food components, sometimes having a wrapper or the like.

Mainly two categories of products of this kind are known, i.e. edible containers for warm and cold food.

With reference to the category of warm food and, in particular, to hollow edible containers having an opening at an end, pizza cones are known, as described in U.S. Pat. No. 4,463,021. Pizza cones can be stuffed with a conventional pizza dressing such as mozzarella or other cheese, tomato or other sauces, delicatessen, olives and the like. Other edible cones that can be filled with warm food are described in EP 0313791.

Warm food products of this kind can be obtained either introducing in the edible container the components when they are still cold and then heating the whole product, or heating the components before putting them in the container.

A device falling in the former case is described in WO2005039296. This system has the drawback of a slower preparation time, in fact after having filled manually the edible container, the product is arranged in a heating chamber where the product gets warmer starting from its outer surface up to reaching the core region. This operation requires quite a long time often incompatible with the need of rapidity of food distribution points. With this system there is the further drawback to provide a product with higher temperatures on the external surface, which operatively is in contact with the hand of the user, and a lower temperature in the core portion. A device falling in the latter case, instead is described in WO2006061187. It comprises a heating chamber having a surface that can be heated by contact on which at least one previously chopped food component is arranged. This way, the heat exchange surface considerably increases for heating the food component, thus obtaining a homogeneous heating of the component that is then quickly put in the edible container. Therefore, the problems are solved of production time and of high external temperature of the edible container. In a possible exemplary embodiment the heating surface belongs to a rotating disc in a horizontal plane on which the chopped component moves and where heating is carried out with an electric resistance. Alternatively, the heating surface is a fixed surface. This system, even if it solves the technical problems of heating rapidity and quality of the product, has the drawback that a pushing element is necessary for scraping the molten cheese from the plate and for bringing it towards an outlet portion. Furthermore, the operation of cleaning the surfaces from cheese is complex.

It is also felt the need of automatically preparing doses of a warm food product according to various recipes, in particular for pizza, which comprise parts of cheese, tomato, ham and other components, combined to each other according to various combinations.

### SUMMARY OF THE INVENTION

It is a feature of the present invention to provide a device for supplying a single-dose portable express portion of a warm food product that can be eaten keeping it in hand in an edible container, which can be filled with different food components, overcoming the above drawbacks.

Another feature of the present invention is to provide such a device capable of transforming in a short time at least one food component, for example cheese, by shredding, heating and homogenizing this component for then putting it in an edible container.

A further feature of the invention is to provide such a device capable of allowing an easy inspection for carrying out cleaning operations.

It is still a feature of the invention to provide such a device that requires short time for preparing the product.

Another feature of the present invention is to provide such a device that is adapted to carry out all the above described operations automatically according to tastes and preferences of the user.

Another feature of the present invention is to provide a device that is capable of creating automatically a warm food product according to various recipes based on cheese and other ingredients automatically according to tastes and preferences of the user.

These and other objects are achieved by an apparatus for supplying a single-dose portable express portion of a warm food product that can be eaten keeping it in hand, this warm food product consisting of an edible container and a stuffing consisting of at least one food component comprising cheese, said apparatus comprising:

means for supporting said edible container,

means for quickly heating said component, and

means for putting in said container said heated component, creating a combination of said heated component and said container, said means for quickly heating comprising:

a heating chamber for said at least one component having an inlet and an outlet;

means for conveying said at least one component from a first position to a second position through said heating chamber, said conveying means receiving in said first position said chopped food component heating elements for heating and melting said at least one food component on said conveying means while being conveyed from said first to said second position; characterized in that said conveying means comprises at least one conveyor belt arranged in said chamber, said belt carrying said food component from said first to said second position while said heating elements heat said food component.

Advantageously, said means for heating and melting comprises at least one heat source selected from the group comprised of:

an electric resistance;

a lamp;

a microwave source;

a hot air stream; a gas cooker capable of heating said at least one component arranged on said conveying means.

In particular, said heat source comprises means for coupling its intensity. In particular, said at least one lamp is of halogen type.

In a possible exemplary embodiment, said apparatus comprises means for feeding said at least one component towards said conveying means.

In particular, said feeding means comprises an auxiliary conveyor, arranged above said conveyor belt and adapted to bring said food component upstream from said conveyor belt.

In particular, said auxiliary conveyor is of belt type.

Advantageously, a chute guide is provided arranged downstream of and at a minimum distance from said auxiliary conveyor to assist said chopped component to leave said conveyor belt.

In particular, said conveyor belt and/or said auxiliary conveyor belt are made of a non-stick material selected from the group comprised of:

silicone rubber;

paper;

gum or polymer;

metal;

a combination of said materials.

In particular, said apparatus comprises means for shredding said or each component before reaching said conveying means.

Advantageously, said means for shredding are adapted to move relatively with respect to said conveying means and/or said feeding means, in order to spread said at least one chopped component on said conveying means.

In particular, said means for shredding are arranged according to positions selected from the group comprised of:

above said means for feeding, upstream from said auxiliary conveyor belt, in order to shred said food component before distributing it on said auxiliary conveyor belt, said auxiliary conveyor belt transporting said chopped food product upstream from said conveyor belt;

downstream of said auxiliary conveyor belt, said means for shredding receiving a chopped food component from said auxiliary conveyor belt, said means for shredding supplying said chopped food component upstream from said conveyor belt, said auxiliary conveyor belt being preferably thermally insulated from said lamp;

upstream from said conveyor belt, supplying directly a chopped food component to said conveyor belt.

In a possible exemplary embodiment, said apparatus comprises an automatic feeding device of at least one food component, said food component being in single sealed units, in particular selected from the group comprised of:

a cartridge,

a closed bag.

In particular, said feeding device being capable of opening said cartridge or bag and of squeezing out said food component, supplying said component to said conveyor belt or to said auxiliary conveyor belt or to said means for shredding. This way, by opening manually or automatically the cartridge or the bag, an already chopped component is supplied directly upstream from the belt or to said means for shredding that can be arranged upstream from or downstream of the auxiliary conveyor belt.

Alternatively, said apparatus comprises an automatic feeding device of at least one chopped food component, wherein said or each component is contained in a respective rechargeable container, which is associated to said automatic feeding device and has an outlet operated on demand, said component being conveyed, after said outlet, to said conveyor belt or to said auxiliary conveyor, said operated outlet having in particular, means for shredding said chopped food component, in particular, said means for shredding comprising a couple of parallel counter-rotating rollers. The rollers can be arranged either at the outlet of said automatic device, or at the entrance of the apparatus.

Advantageously, said automatic feeding device comprises cooling means adapted to preserve said at least one chopped food component at a temperature lower than 0° C., in particular, less than −10° C., preferably −18° C.

Advantageously, said apparatus comprises means for heating said edible container before putting said at least one food component in said container, once heated.

In a possible exemplary embodiment, said apparatus comprises means for adding a liquid or creamy component to said at least one component in a position selected from the group comprised of:

on the surface of said conveyor belt;

downstream of said conveyor belt;

at said edible container.

This way, this liquid or creamy component, for example tomato sauce, can be added directly on the conveyor belt, in which case a belt of disposable material would be suitable, for example paper, and coupling it each time, either downstream of the belt or directly at the edible container.

Preferably, said means for adding a liquid or creamy component comprises a dosing device that can be opened in an automatic or timed-out or driven way.

Advantageously, said apparatus for supplying a single-dose portion of said warm food product comprises means for adding at least one food dressing component on said portion.

In an exemplary embodiment of the invention, said apparatus is contained completely in a stiff box, creating a vending distributor, adapted to deliver said single-dose portion automatically on demand of the user.

In particular, said at least one food component is selected from the group comprised of:

cheese or mozzarella; meat or delicatessen;

fresh or preserved vegetables;

in oil or pickled food;

fish;

a combination of said components.

In particular, said edible container is a baked product.

In particular, said edible container has shape selected from the group comprised of:

convex shape, such as a panino, a brioche, a piadina;

a thin walled hollow shell, selected from the group comprised of:

a geometrical figure, such as a spherical, cylindrical, conic, cubic wafer etc.;

a fruit or a vegetable piece;

an animal, a character, a flower, etc.;

a common object.

Advantageously, said means for supporting said edible container comprises an element for holding and arranging said edible container at said outlet of the heating chamber, said element for holding having a housing for said edible container and a handle, said housing having a fixed or adjustable opening, said element for holding having, in particular, means for coupling to said outlet of the heating chamber, said means for coupling being preferably bayonet coupling.

According to another aspect of the invention, an apparatus to prepare a warm food product comprises an automatic feeding device of a plurality of shredded food components and means for heating a combination of at least two of said food components, said automatic feeding device comprising a container for each shredded food component, said container having a filling inlet of said product and an outlet equipped with means for releasing on demand predetermined doses of said component, said component being conveyed, after said outlet, on an edible support, cooling means being provided where said containers are housed, adapted to preserve said at least one chopped component at a temperature lower than 0° C., in particular, less than −10° C., preferably −18° C.

### BRIEF DESCRIPTION OF THE DRAWINGS

The invention will be made clearer with the description of some exemplary embodiments, exemplifying but not limitative, with reference to the attached drawings wherein:

FIG. 1 shows a perspective view of an example of apparatus according to the invention having a conveyor belt and an auxiliary conveyor, and capable of shredding a food component, for example cheese, and heating it before putting it in an edible container;

FIG. 2 shows diagrammatically such a machine having means for shredding this food component arranged upstream from the auxiliary conveyor belt;

FIG. 3 shows diagrammatically another exemplary embodiment having the means for shredding arranged downstream of the auxiliary conveyor belt, which this way is adapted to carry the chopped component;

FIG. 4 shows a different exemplary embodiment having one heated conveyor belt and shredding means arranged upstream of it;

FIG. 5 shows an example of such an apparatus having a automatic feeding device of the component packaged in sealed single-dose units, for example a cartridge;

FIGS. 6 and 7 show further exemplary embodiments of the present invention, where the food component is kept and fed already chopped to the apparatus and then distributed respectively on the conveyor belt or on the auxiliary conveyor,

FIG. 8 shows a preferred exemplary embodiment of an apparatus according to the invention, having a conveyor belt, a device for feeding the frozen food components and an element for holding the edible container;

FIGS. 9 and 10 show two possible examples of such a feeding device;

FIG. 11 shows a partial cross sectional view of an apparatus according to the invention contained in a box shaped carter and forming an automatic distributor;

FIGS. 12 and 13 show two possible exemplary embodiments of an element for holding the edible container.

### DESCRIPTION OF PREFERRED EXEMPLARY EMBODIMENTS

In the following description an apparatus is described for preparing and supplying a single-dose portable express portion of a warm food product that can be eaten keeping it in hand. In particular, this warm food product comprises an edible container and a stuffing of at least one food component such as a typical dressing component of a pizza, in particular comprising cheese.

Such an apparatus according to the invention, is capable of heating and melting this food component in a short time, after having chopped it finely, and then of putting it in the edible container, creating a heated combination of the edible container and of the stuffing. Such a warm food product is suitable, then, to be eaten keeping it in hand like a sandwich, but it is produced expressly with freshly handled food components, preserving completely their freshness and hygiene of the stuffing as well as the fragrance of the edible container just filled with this stuffing. Since the warm food product is produced expressly, the apparatus according to the invention, achieves also the requirement of quick working time.

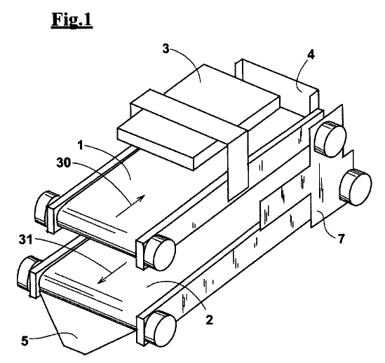

Such an apparatus, in a first embodiment according to the invention, is shown in FIG. 1 as a perspective view. It comprises a conveyor belt 2, arranged below an auxiliary conveyor, for example an auxiliary conveyor belt 1, so that the food component arranged on auxiliary conveyor belt 1 can fall on conveyor belt 2 in a zone downstream of auxiliary conveyor belt 1 and upstream from conveyor belt 2. This way, such conveyor belts 1 and 2 can be substantially horizontal and overlapping partially or completely each other, whereby such conveyor belts 1 and 2 move in opposite directions to each other according to arrows 30 and 31, as shown in FIG. 1. Obviously such conveyor belts 1 and 2 can be arranged also with a small slope, according to handling and viscosity reasons of the component, and are mounted not overlapping in a way not shown in the figures.

Furthermore, in the example shown in FIG. 1, the apparatus comprises means for shredding the food component and, in particular, a shredder 3 of prior art arranged above the auxiliary conveyor belt 1 and substantially upstream from belt 1 same. Between auxiliary conveyor belt 1 and conveyor belt 2 at least one lamp is present, for example a halogen lamp, not shown in FIG. 1 but visible in the following figures, indicated with 10. The thermal energy irradiated by this lamp 10 can freely achieve conveyor belt 2, heating and/or melting the shredded food component, in particular, cheese, present on this belt during its passage. This transmission of energy is preferably shielded in 11 with respect to auxiliary conveyor belt 1, thus heating only conveyor belt 2. Downstream of conveyor belt 2 a chute plane is arranged at an angle adapted to convey this component already heated and molten in the edible container and then to complete the warm single-dose food product. Still in FIG. 1, a deflecting element 4 is shown to assist the passage and the distribution of the chopped and cold component present on auxiliary conveyor belt 1 towards conveyor belt 2, on which this component is heated and molten.

The edible container, not shown in the figure, is a baked product obtained with the typical ingredients of the base of a pizza, such as flour, water, yeast, salt, etc. and it has the function of a cup-shaped container having, for example, the shape of a cylinder, a frustum of cone, a cone, a sphere, etc.

The food components are those typical of the dressing of a pizza, for example cheese or mozzarella, sauces, capers, olives, delicatessen, anchovies, etc., but can comprise also other components, for example molten chocolate, sweet creams.

The food product thus obtained can be completed with at least one food dressing component arranged on top of the food product after having stuffed the edible container with the component/s.

Such a machine is adapted to be automatic, for example arranging it in an box-shaped vending machine adapted to deliver automatically single-dose express warm food product on demand of the user.

FIG. 2 shows diagrammatically an apparatus as already described in FIG. 1. The shredder 3, arranged upstream from the auxiliary conveyor belt 1, is fed by at least one chopped component 20, for example mozzarella, and delivers the still cold chopped component 21 leaving it to fall on auxiliary conveyor belt 1 that moves towards arrow 30 up to falling on conveyor belt 2, which is exposed to the irradiation of lamps 10. Preferably, the path of the chopped food component 21 between shredder 3 and auxiliary conveyor belt 1 is protected by a carter, not shown in the figure, adapted to avoid that particles of the chopped product are dispersed by the kinetic energy of the same at the outlet of shredder 3. The chopped component is released from auxiliary conveyor belt 1 assisted by the presence of a chute guide 25 arranged downstream of and at a minimum distance from auxiliary conveyor belt 1. In particular, chute guide 25, located in fixed position, acts as scraper during the motion of the conveyor belt. This way, chopped component 21, once reached conveyor belt 2, is heated and/or molten by the energy irradiation by lamps 10, creating a soft and homogeneous component 22 that is delivered on chute plane 5 forming the warm food component 23 that fills edible container 24.

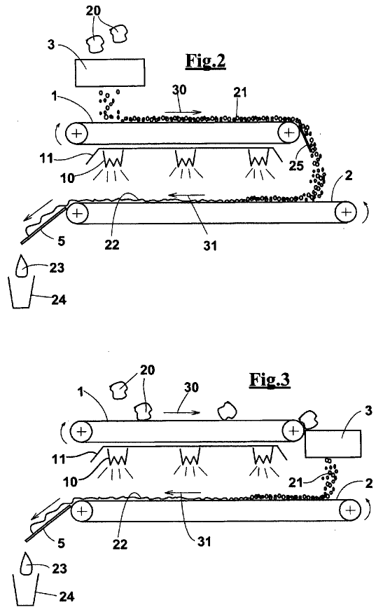

FIGS. 3, 4 and 5, instead, show respective exemplary alternative embodiments of the invention; in particular, FIG. 3 shows an apparatus according to the invention having a shredder 3 downstream of auxiliary conveyor belt 1. This way, the chopped food component 20 is arranged on auxiliary conveyor belt 1 and transported towards shredder 3, that outputs the shredded food component 21. The latter moves on conveyor belt 2 and then is heated and/or molten by irradiation of lamps 10. Then the molten component 22 forms the warm food component 23 and reaches edible container 24 like in the previous figure.

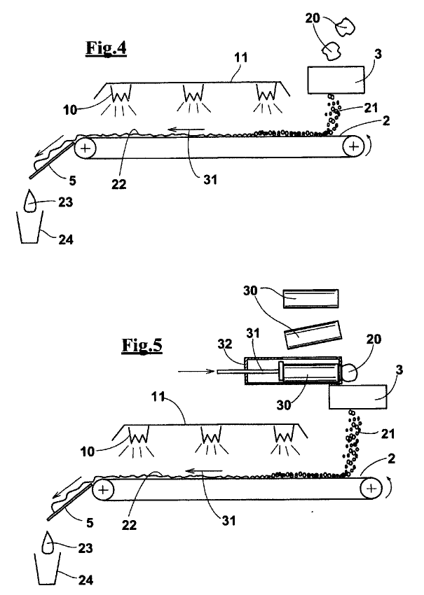

Alternatively, as shown in FIGS. 4 and 5, the apparatus according to the invention can comprise only conveyor belt 2 and not auxiliary conveyor belt 1, whereby the chopped component is fed directly to shredder 3 or onto conveyor belt 2.

A possible embodiment of a feeding unit for the food component, shown in FIG. 5, provides a food component in sealed units, for example contained in a cartridge 30, and an automatic device 32 for feeding the food component 20 is provided, capable of opening said cartridge 30 and squeezing out said food component 20 supplying it to conveyor belt 2, or to auxiliary conveyor belt 1, or to shredder 3.

Obviously, automatic device 32 can be used also in all the other exemplary embodiments already described in the previous figures, allowing the introduction of one or more components 20 extracted from cartridge/s 30, at the entrance of a shredder 3, which is capable of chopping finely such components to obtain a very high heat exchange surface for melting quickly all the components.

If the component contained in such cartridge is already finely chopped, shredder 3 is obviously unnecessary.

FIG. 6 shows further exemplary embodiments of the present invention, where the food component 21 is provided to auxiliary conveyor 1, already chopped or shredded, by a distributor, for example a hopper 27, and then distributed onto conveyor belt 2. This way a shredder is not necessary because the food component is already in appropriate conditions for being heated and molten very quickly.

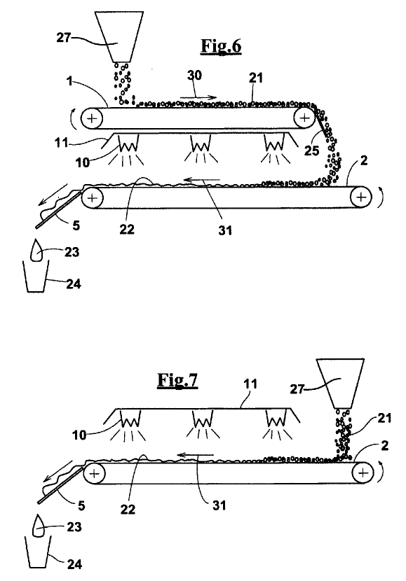

FIG. 7 shows a similar exemplary embodiment where auxiliary conveyor 1 is not present, whereby the food component, already chopped or shredded, is put directly onto conveyor belt 2.

Obviously, also in these cases an automatic feeding device 32 can be used as described in FIG. 5, where the cartridge 30 contain at least one food component already chopped/shredded and ready to be heated and molten when it reaches conveyor belt 2.

In FIG. 8 a preferred exemplary embodiment of the apparatus according to the invention is diagrammatically described, having a conveyor belt 2, upstream from which at least one already chopped food component 21 is deposited, which along the path of conveyor belt 2 is heated and molten for then being put, as a hot and molten warm food component 23, into edible container 24. Heating is carried out by irradiation by a heat source 10, for example a lamp or an electric resistance. A further electric resistance can be provided, not shown in FIG. 8, arranged under conveyor belt 2 or within the loop formed by conveyor belt 2. The power of source 10 and/or the distance between source 10 and food component 22 is variable according to the intensity of heat treatment that is required for component 22.

The apparatus according to the invention of FIG. 8 comprises a feeding device 27 capable of feeding more shredded food components, mixed together in turn according to a recipe chosen by the user. More in detail, this feeding device 27 comprises inside one or more different boxes 57 containing already shredded loose food components 52. Each container 57 has an opening at its base and a stopping element 51 that can be opened automatically on demand. When the stopping element 51 is open, the corresponding food component falls by gravity reaching an outlet 53 of feeding device 27, and, in case of more components, is mixed with the others. At this outlet 53 a stopping element 55 can be provided that can be opened automatically by an outer drive. Feeding device 27 of FIG. 8 comprises freezing means, not shown, capable of preserving the shredded food components 52 at an optimal preservation temperature, for example −18[deg.]C. Furthermore, a ventilation system can be provided 50 in the frozen zone for reducing water condensation.

FIG. 8, furthermore, shows the use of a holding element 40 for edible container 24, described hereinafter in more detailed way in FIGS. 12 and 13.

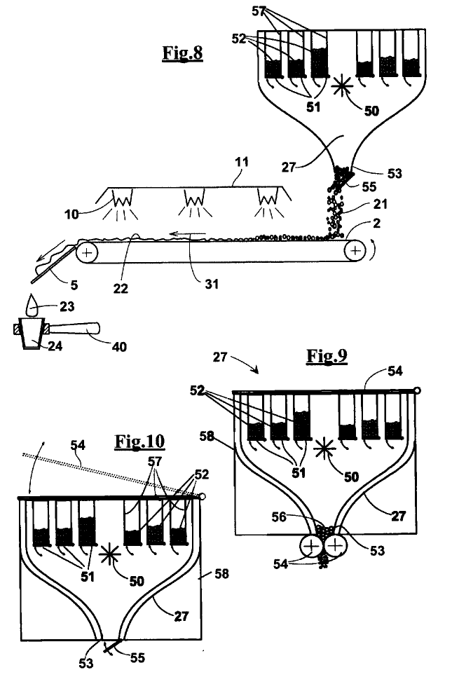

FIG. 9 or FIG. 10 show a cross sectional view of two exemplary embodiments of an automatic device 27 according to the invention, for feeding a plurality of shredded food components. It is based on the same principles already described in FIG. 8, and can be either associated to an apparatus like in FIG. 8, or it can be associated to other apparatus for distributing a warm food product according to various recipes of combination of components.

In FIG. 9, at outlet 53 of feeding device 27, two parallel horizontal counter rotating rollers 54 are provided capable of separating the shredded food component that could aggregate and stick owing to freezing. Such a system allows assuring that the shredded parts are all distinct from each other. As shown in FIG. 9 and FIG. 10, a cover can be provided that can be opened 54 capable of protecting the food components 52 contained in the respective containers 57. Furthermore, feeding device 27 can be contained in a freezing box 58 capable of preserving the shredded food components 52 at a optimal conservation temperature, for example −18<0>C. Box 58 can comprise an inspection door not shown. The parts of feeding device 27 that are operatively in contact with the food components can be removable in order to clean them easily.

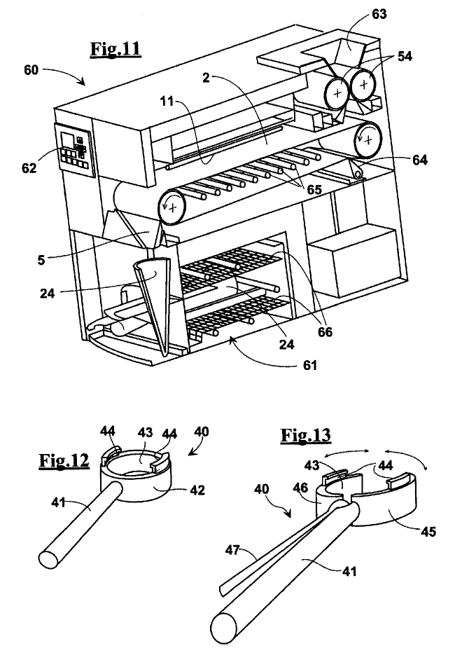

In FIG. 11 an alternative exemplary embodiment of the apparatus of FIG. 4 according to the invention is shown. It is contained in a carter 60 that may have a keyboard 62 capable of receiving input controls by a user, who can choose a recipe on demand, corresponding to a particular combination of food components and to a particular succession of preparation steps. This way an express recipe of the food product can be distributed by the apparatus. Furthermore, it is also possible to choose a dressing or ‘top’, always by the present apparatus, with which the product is topped. The combination of food components and the appropriate succession is computed by a programmable central control unit, capable of storing a plurality of recipes.

The apparatus described in FIG. 11 has an inlet 63 for food components to heat, at which a feeding device can be mounted, for example feeding device 27 shown in FIGS. 8, 9, 10. The food product at said inlet is then ground by the action of rollers 54 that, while rotating with opposite directions, bring the components in the heating chamber comprising conveyor belt 2. Downstream of conveyor belt 2 a blade is present at an angle 5 arranged in order to sweep the surface of conveyor belt 2 and cause the molten food components to fall away from conveyor belt 2 at the outlet. Heating means 11 by irradiation are provided, for example an electric resistance or a lamp, arranged above conveyor belt 2 in order to heat directly the food components. In addition supplementary resistances 65 can be provided arranged below conveyor belt 2, or as shown in FIG. 11, in the loop formed by the conveyor belt. Such resistance can keep the conveyor belt 2 at a fixed desired temperature. A heating zone 61 for cones 24 or other edible containers is also provided, in order to keep them warm before being stuffed, wherein this zone 61 is heated for example by means of a further electric resistance.

FIG. 12 shows a holding element 40 for the edible container to be arranged at the outlet of the heating chamber. This element 40 has a housing 43 in which edible container 24 can be put (see also FIG. 8) and a gripping handle 41, as well as it has bayonet coupling portions 44 for coupling the holding element 40 to the apparatus at the outlet 5 of the warm food component 23, by engagement with co-operating portions not shown.

FIG. 13 shows another exemplary embodiment of such a holding element 40, where housing 43 is open and it is defined by two gripping shrouds 45 and 46 hinged and movable relatively to each other by the action of an opening lever 47. In this way the introduction and the release of the hot cone is assisted without that the operator has to touch it directly.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realize the different functions described herein could have a different nature without, for this reason, departing from the field of the invention. It is to be understood that the phraseology or terminology employed herein is for the purpose of description and not of limitation.

What is claimed is:

1. An apparatus for supplying a single-dose portable express portion of a warm food product that can be eaten keeping it in hand, this warm food product comprising an edible container and a stuffing including at least one shredded food component comprising cheese, said apparatus comprising:
means for supporting said edible container,
means for quickly heating said component, and
means for putting said heated component in said container, creating a combination of said heated component and said container,
said means for quickly heating comprising:
a heating chamber for said at least one component having an inlet and an outlet;
means for conveying said at least one component from a first position to a second position through said heating chamber, said conveying means receiving in said first position said shredded food component;
heating elements for heating and melting said at least one food component on said conveying means while being conveyed from said first to said second position;
characterized in that said conveying means comprises at least one conveyor belt arranged in said chamber, said belt carrying said food component from said first to said second position while said heating elements heat said food component.

2. The apparatus of claim 1, wherein said heating elements for heating and melting comprises at least one heat source selected from the group consisting of: an electric resistance, a microwave source, a lamp, a hot air stream, and a gas stove, capable of heating said at least one component arranged on said conveying means.

3. The apparatus of claim 1, comprising means for feeding said at least one component towards said conveying means having an auxiliary conveyor arranged above said conveyor belt and adapted to bring said food component upstream from said conveyor belt.

4. The apparatus of claim 3, wherein the auxiliary conveyer comprises a belt-type conveyer.

5. The apparatus of claim 1, wherein said conveyor belt or said auxiliary conveyor belt are made of a non-stick material selected from the group consisting of:
silicone rubber;
paper;
gum or polymer;
metal; and
a combination of said materials.

6. The apparatus of claim 1, comprising means for shredding said or each component before reaching said conveying means, said means for shredding being operatively in relative movement with respect to said conveying means, in order to spread said at least one shredded component on said conveying means.

7. The apparatus of claim 1, comprising an automatic feeding device of at least one food component, said food component being in a single sealed unit cartridge, said device being capable of opening said cartridge and squeezing out said food component, supplying said component to said conveyor belt or to said auxiliary conveyor belt or to said means for shredding.

8. The apparatus of claim 1, comprising an automatic feeding device of at least one chopped food component, wherein said or each component is contained in a respective rechargeable container having an outlet operated on demand, said component being directed towards said outlet, having means for shredding said chopped food component, said means for shredding comprising a couple of parallel counter-rotating rollers.

9. The apparatus of claim 8, wherein said automatic feeding device comprises cooling means adapted to preserve said at least one chopped component at a temperature lower than 0° C.

10. The apparatus of claim 1, wherein the cooling means is adapted to preserve said at least one chopped component at a temperature between −10° C., and −18° C.

11. The apparatus of claim 1, wherein said apparatus comprises means for heating said edible container before putting said at least one food component in said container, once heated.

12. The apparatus of claim 1, wherein said apparatus comprises means for adding a liquid or creamy component to said at least one component in a position selected from the group consisting of:
on the surface of said conveyor belt;
downstream of said conveyor belt; and
at said edible container.

13. The apparatus of claim 1,
wherein said at least one food component is selected from the group consisting of:
cheese or mozzarella;
meat or delicatessen;
fresh or preserved vegetables;
in oil or pickled food;
fish; and
a combination of said components,
and wherein said edible container is a baked product, with shape selected from the group consisting of:
convex shape; and
a thin walled hollow shell, selected from the group consisting of:
a geometrical figure;
a piece of fruit or vegetable;
a animal, a character, or a flower; and
a common object.

14. The apparatus of claim 13, wherein:
the convex shape comprises a panino, a brioche, or a piadina; and
the geometrical figure comprises a spherical wafer, cylindrical, conic or a cubic figure.

15. The apparatus of claim 1, wherein said means for supporting said edible container comprises an element for holding and arranging said edible container at said outlet of the heating chamber, said element for holding having a housing for said edible container and a handle, said housing having a fixed or adjustable opening, said element for holding having means for coupling to said outlet of the heating chamber.

16. The apparatus of claim 15, wherein said means for coupling comprises a bayonet coupling.

17. An apparatus to prepare a warm food product, comprising an automatic feeding device of a plurality of shredded food components and means for heating a combination of at least two of said food components, said automatic feeding device comprising a box for each shredded food component, said container having a filling inlet and an outlet equipped with means for releasing on demand predetermined doses, said component being conveyed, after said outlet, on an edible support, cooling means being provided where said boxes are housed, adapted to preserve said at least one chopped component at a temperature lower than 0° C.

18. The apparatus of claim 17, wherein the cooling means is adapted to preserve said at least one chopped component at a temperature between −10° C. and −18° C.
